(19) United States
(12) Patent Application Publication
(10) Pub. No.: US 2024/0375244 A1
(43) Pub. Date: Nov. 14, 2024

(54) GRINDING WORM, METHOD FOR PRODUCING A GRINDING WORM AND USE OF A GRINDING WORM

(71) Applicant: Klingelnberg AG, Zürich (CH)

(72) Inventor: Sebastian Stramm, Köln (DE)

(21) Appl. No.: 18/657,314

(22) Filed: May 7, 2024

(30) Foreign Application Priority Data
May 12, 2023 (EP) 23173215.7

(51) Int. Cl. B24D 5/14; B23F 5/04; B23F 21/02; B24D 7/18

(52) U.S. Cl. CPC B24D 5/14; B23F 5/04; B23F 21/026; B24D 7/18

(57) ABSTRACT

A grinding worm being a dressable grinding worm, wherein a first section of the grinding worm has a first abrasive grain which is incorporated in a matrix material and wherein a second section of the grinding worm has second abrasive grain which is incorporated in the matrix material. The first abrasive grain and the second abrasive grain differ from one another in terms of grain size and/or grain material. A transition section is formed between the first section and the second section, in which both the first abrasive grin and the second abrasive grain are incorporated in fie matrix material, wherein the first section, the second section and the transition section have the same matrix material and wherein an intermixing of the first abrasive grain and the second abrasive grain is formed at least in sections in the transition section.

### CROSS-REFERENCE TO RELATED APPLICATIONS

This application claims the benefit of European patent application 23173215.7, filed on May 12, 2023, the disclosure of which is incorporated herein by reference in its entirety.

### TECHNICAL FIELD

The present disclosure relates to a grinding worm and a method for producing such a grinding worm as well as the use of such a grinding worm.

### BACKGROUND

Grinding worms are used to grind gears using the continuous generating grinding process. A classic example of gears that can be finish-machined by generating grinding are spur or helical gears.

Generating grinding itself can take place in several steps, wherein a larger amount of material is first removed in a first overrun, known as rough machining or rough grinding, and then a smaller amount of material is removed in one or more further overruns, known as finishing or finish grinding. Depending on the required quality, a distinction can be made between fine grinding and polishing grinding with regard to finishing.

It can be seen that a coarser abrasive grain can be used for rough grinding than is the case for fine grinding. In order to avoid having to provide a separate grinding worm with the correspondingly required abrasive grain for each work step, it is known to use grinding worms that have both a coarse abrasive grain and a fine abrasive grain. These grinding worms are provided, for example, in such a way that a first module of the respective grinding worm has a coarse abrasive grain with a ceramic bond and a second module of the grinding worm has a fine abrasive grain with a synthetic resin bond. The two modules are bonded together, for example, in order to provide a grinding worm with two different grain sizes. However, each of the two modules is initially manufactured separately and independently of the other module. In other words, these are two separate grinding worms with different grain sizes that have been joined together to form one grinding worm.

Such grinding worms are therefore complex to manufacture, wherein the joint between the two modules represents a weak point that can lead to defects during use of the grinding worm in question or during dressing across the joint.

### SUMMARY

Against this background, the present disclosure is based on the technical problem of providing an improved grinding worm having at least two grain sizes or having at least two areas with different removal behavior, which can be produced in particular at low cost and is also robust over its entire service life—both during grinding and during dressing. Furthermore, a method for producing and using such a grinding worm is to be specified.

The technical problem described above is solved in each case by the independent claims. Further embodiments of the disclosure result from the dependent claims and the following description.

According to a first aspect, the disclosure relates to a grinding worm, wherein the grinding worm is a dressable grinding worm, wherein a first section of the grinding worm has first abrasive grain which is incorporated in a matrix material, wherein a second section of the grinding worm has second abrasive grain which is incorporated in the matrix material, wherein the first abrasive grain and the second abrasive grain differ from one another in terms of grain size and/or grain material and/or shape, wherein a transition section is formed between the first section and the second section, in which both the first abrasive grain and the second abrasive grain are incorporated in the matrix material, wherein the first section, the second section and the transition section have the same matrix material and wherein an intermixing of the first abrasive grain and the second abrasive grain is formed at least in sections in the transition section.

In particular, the first section and the second section have been joined together by primary molding, so that the transition section forms a material bond between the first section and the second section. In other words, the first section, the second section and the transition section have been provided in integrally as an integral blank by primary molding, so that no joint and no bonding point is formed between the first section and the second section.

The grinding worm designed in accordance with the disclosure can therefore be manufactured particularly cost-effectively and is also robust over its entire service life—both during grinding and during dressing. This can be achieved in particular in that both the first abrasive grain and the second abrasive grain are embedded in one and the same matrix material for primary molding.

When reference is made here to a grain size of the abrasive grain, this refers in particular to an average grain size, wherein the average grain size can be defined in particular by a grain size range. For example, it may be provided that an average grain size of the first abrasive grain is in a range of 0.06 mm-0.12 mm, while an average grain size of the second abrasive grain is in a range of 0.14 mm to 0.22 mm. In this case, the second abrasive grain is therefore a coarser abrasive grain, while the first abrasive grain is a finer abrasive grain in comparison.

According to one embodiment of the grinding worm, the first section has a coarser abrasive grain than the second section—or vice versa,

The first abrasive gran can be an abrasive grain mixture. The second abrasive grain can be an abrasive grain mixture.

The first abrasive grain can consist of corundum or aluminum oxide.

The first abrasive grain can consist of silicon carbide.

The first abrasive grain can consist of cubic boron nitride. The first abrasive grain can be made of synthetic diamond.

The first abrasive grain may comprise a mixture of abrasive grains consisting of two or more of the aforementioned materials.

The second abrasive grain can consist of corundum or aluminum oxide.

The second abrasive grain can consist of silicon carbide. The second abrasive grain can consist of cubic boron nitride.

The second abrasive grain can consist of synthetic diamond.

The second abrasive grain may comprise a mixture of abrasive grains consisting of two or more of the aforementioned materials.

It may be provided that the grinding worm is a ceramic bonded grinding worm. Accordingly, the matrix material is a ceramic bond,

The matrix material may comprise one or more of the following materials: Clay, kaolin, feldspar, quartz and porcelain powder, calcite, iron oxide, glass frit. The matrix material can be, for example, an amorphous bond, i.e. a fusion bond with a high glass phase content, or can be, for example, a bond with a medium glass phase content, or can be, for example, a porcelain-like sintering bond, i.e. a sintering bond, with little or no glass phase content.

According to alternative embodiments, it may be provided that the grinding worm has a synthetic resin bond as a matrix material.

The first abrasive grain and/or the second abrasive grain can differ from one another in terms of their shape, wherein the first abrasive grain and the second abrasive grain can in particular each have a different shape or form, selected from: hexahedron, rhombohedron, tetrahedron, octahedron, pyramid, trapezohedron, prism.

The first section and the second section can differ from each other in terms of their pore content. For example, the first section can have a larger proportion of pores than the second section—or vice versa.

The first section and the second section can differ from each other in terms of their pore size. For example, the first section may have larger pores than the second section or vice versa.

In particular, the grinding worm is not an electroplated grinding worm.

It may be provided that the first section has a first dressed profile shape and the second section has a second dressed profile shape, wherein the geometry of the first dressed profile shape differs from the geometry of the second dressed profile shape, wherein the grinding worm is set up for topological grinding of a gearing.

According to the disclosure, the term “topological grinding” comprises both the generation of classical modifications of the gearing, such as retractions in the region of the tooth tip, the tooth root or the tooth ends, crowning in the profile and/or flank direction or also angular modifications in the profile and/or flank direction, as well as a superposition of classical modifications. According to the disclosure, the term “topological grinding” also includes the generation of modifications of the gearing, wherein tooth flanks of the gearing are viewed as a grid or free-form surface and modification values are freely specified on the basis of support points on this grid. This makes it possible to define arbitrarily modified flank shapes that are not limited by a predefined catalog of gear modifications. Against this background, the term “arbitrarily modified flank shapes” is limited to flank shapes that enable running gearing.

According to a second aspect, the disclosure relates to a method comprising the steps of: providing first abrasive grain; providing second abrasive grain; providing a matrix material; mixing the first abrasive grain with the matrix material to form a first mixture; mixing the second abrasive grain with the matrix material to form a second mixture; layering the first mixture and the second mixture in a mold; pressing the first mixture and the second mixture within the mold and sintering the first and second mixtures to form a cylindrical blank; producing a grinding worm by profiling the blank; wherein the grinding worm is formed according to the disclosure.

After pressing, a green compact is produced, which is first dried and can then be fired or sintered into the blank by applying heat. The matrix material may contain volatile substances or pore formers that outgas, burn or oxidize during firing.

According to a third aspect, the disclosure relates to a method comprising the steps of: providing a grinding worm according to the disclosure; providing a component having a gearing to be ground; grinding the flanks of the gearing by means of the first section; grinding the flanks of the gearing by means of the second section.

It may be provided that the first section of the grinding worm has a first dressed profile shape and the second section of the grinding worm has a second dressed profile shape, wherein the geometry of the first dressed profile shape differs from the geometry of the second dressed profile shape, wherein the grinding worm is set up for topological grinding of the gearing and the grinding of the flanks of the gearing is a topological grinding.

### BRIEF DESCRIPTION OF THE DRAWINGS

The disclosure is described in more detail below with reference to a drawing which illustrates exemplary embodiments, with the schematic drawings showing in each case:

FIG. 1 shows a grinding worm according to the disclosure;

FIG. 2 shows a mold for sintering;

FIG. 3A shows a cylindrical green compact;

FIG. 3B shows a cylindrical, unprofiled blank;

FIG. 4 shows the grinding worm profiled from the blank according to FIG. 1;

FIG. 5 shows a flow chart of a grinding process according to the disclosure;

FIG. 6A shows grinding with the first section of the grinding worm; and

FIG. 6B shows grinding with the second section of the grinding worm,

### DETAILED DESCRIPTION OF THE DRAWINGS

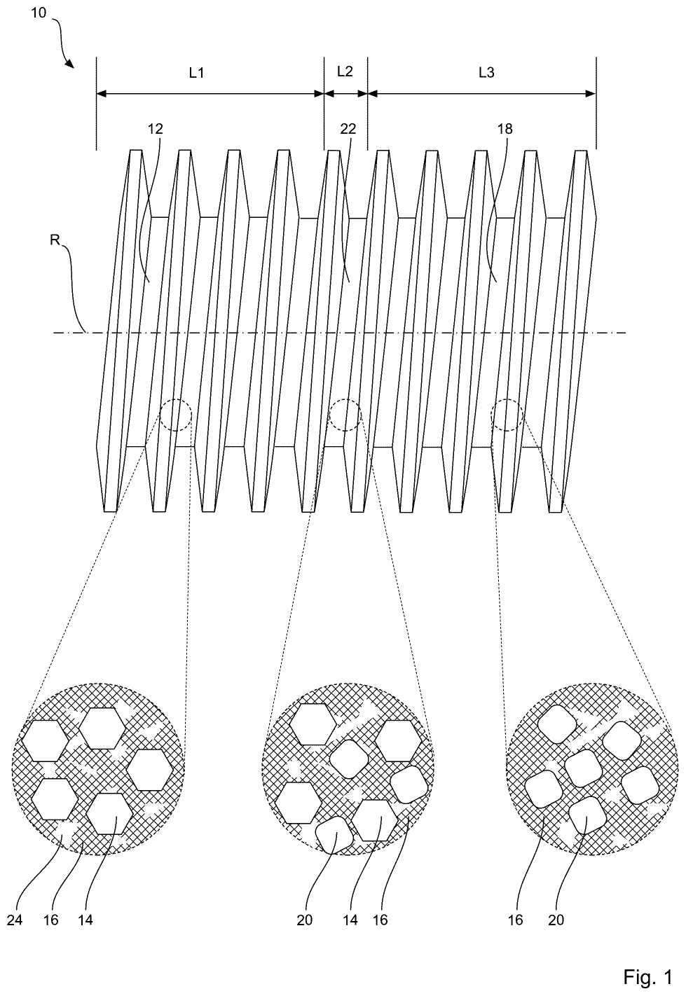

FIG. 1 shows a side view of a grinding worm 10 according to the disclosure.

The grinding worm 10 is a dressable grinding worm. The grinding worm 10 has an axis of rotation R about which the grinding worm 10 is driven in rotation during operation.

A first section 12 of the grinding worm 10 has a first abrasive grain 14. The first abrasive grain 14 is embedded in a matrix material 16.

A second section 18 of the grinding worm 10 has a second abrasive grain 20, which is also incorporated into the matrix material 16.

The first abrasive grain 14 and the second abrasive grain 20 differ from one another in terms of their grain size. In the present case, the second abrasive grain 20 has a smaller average grain size than the first abrasive grain 14.

A transition section 22 is formed between the first section 12 and the second section 18. In the transition section 22, both the first abrasive grain 14 and the second abrasive grain 20 are incorporated into the matrix material 16.

The first section 12, the second section 18 and the transition section 22 have the same matrix material 16 in the present case. The first abrasive grain 14 and the second abrasive grain 20 are intermixed in the transition section 22.

The first section 12 extends along a length L1 with respect to the axis of rotation R. The transition section 22 extends along a length L2 with respect to the axis of rotation R. The second section 18 extends along a length L3 with respect to the axis of rotation R.

In the area of the first section 12, the grinding worm 10 therefore has a first abrasive grain 14 and, in particular, no second abrasive grain 20. In the region of the second section 18, the grinding worm 10 therefore has second abrasive grain 20 and, in particular, no first abrasive grain 14,

It is understood that during production of the grinding worm 10, individual grains of the first abrasive grain 14 may enter the second section 18 and, conversely, individual grains of the second abrasive grain 20 may enter the area of the first section 12. However, the first section 12 has predominantly first abrasive grain 14, i.e. has, for example, more than 90% or more than 95% first abrasive grain, in particular more than 98% first abrasive grain. The second section 18 accordingly has predominantly second abrasive grain 20, i.e. has, for example, more than 90% or more than 95% second abrasive grain 20, in particular more than 98% second abrasive grain.

The percentage values described above refer exclusively to the abrasive grain content of the relevant first section 12 and the relevant second section 18, but not to the total material volume of the relevant sections 12, 18, because the grinding worm 10 is composed of abrasive grain 14, 20, pores 24 and matrix material 16 as a whole. This fact can be seen in the schematically depicted, enlarged views of FIG. 1, which are intended to illustrate the composition and material distribution of the grinding worm 10 in the individual sections 12, 18, 22 in a highly schematized manner.

The grinding worm 10 in this case is a ceramic-bonded grinding worm.

The manufacture of the grinding worm 10 according to the disclosure is described below with reference to FIGS. 2, 3A, 3B and 4,

First, the first abrasive grain 14 and the second abrasive grain 20 are provided.

The first abrasive grain 14 and the second abrasive grain 20 are each mixed separately and independently of one another with matrix material 16. In this way, a first mixture M1 is obtained by mixing the first abrasive grain 14 with the matrix material 16 and a second mixture M2 is obtained by mixing the second abrasive grain 20 with the matrix material 16.

Subsequently, the first mixture M1 is first introduced into a mold 26 and then the second mixture M2 is introduced into the same mold 26. The first mixture M1 and the second mixture M2 are therefore layered within the mold 26 and then pressed into a cylindrical green compact G by applying pressure P.

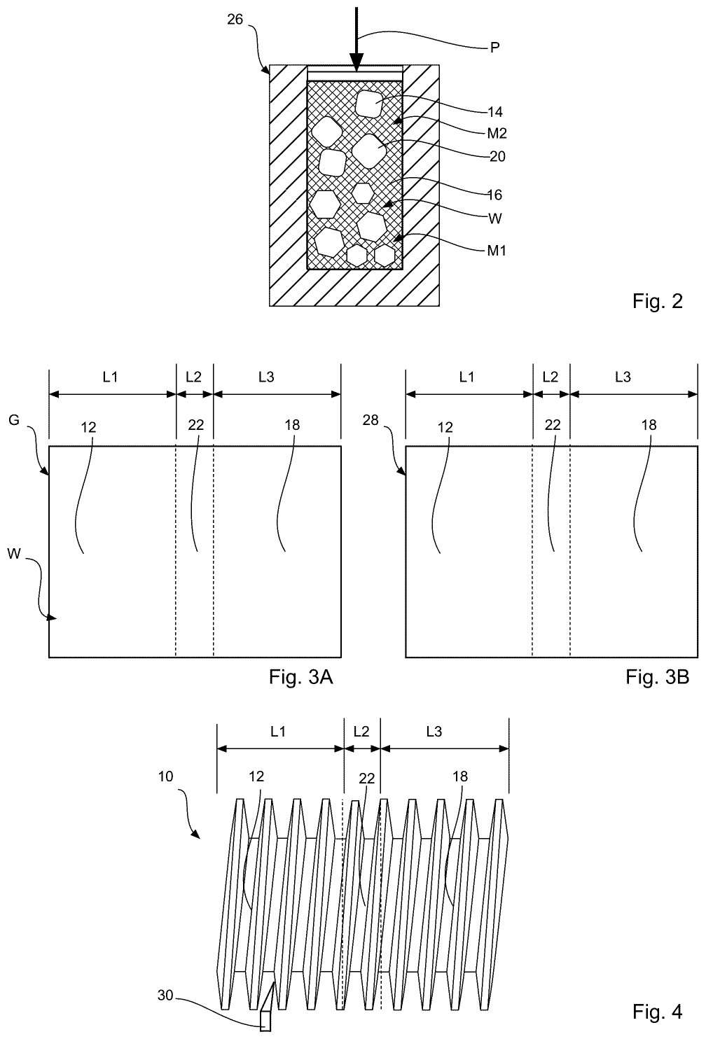

The result of the pressing is therefore the cylindrical green compact G shown in FIG. 3A, which already has the first section 12, the second section 18 and the transition section 22 with the corresponding distribution of the abrasive grain. The green compact G is then sintered to form a cylindrical blank 28 by applying heat W,

The result of the sintering is the cylindrical blank 28 shown in FIG. 3B, which already has the first section 12, the second section 18 and the transition section 22 with the corresponding distribution of the abrasive grain. The grinding worm 10 is finally produced by profiling the blank 28 by means of a tool 30 (FIG. 4), wherein the tool 30 can be a dresser, for example.

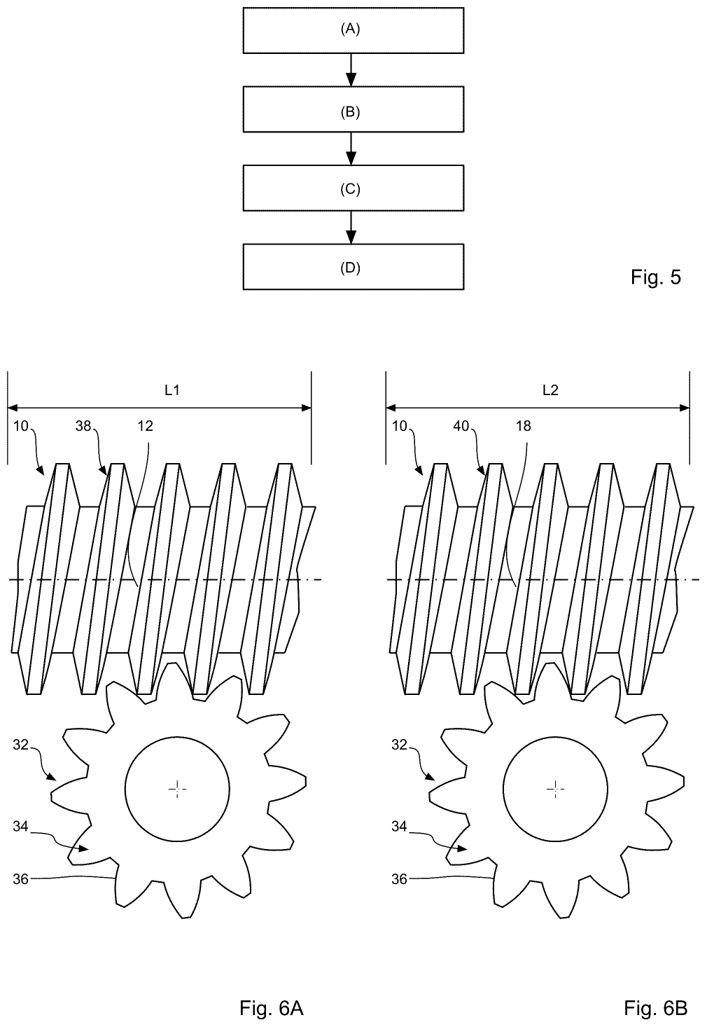

FIG. 5 shows a schematic diagram of a grinding process according to the disclosure.

In a first method step (A), the grinding worm 10 is provided.

In a second method step (B), a component 32 is provided, which has a gearing 34 to be ground.

In a third method step (C), the flanks 36 of the gearing 34 are ground using the First section 12 of the grinding tool to (FIG. 6A).

In a fourth method step (D), the flanks 36 of the gearing 34 are ground using the second section 18 of the grinding tool 10 (FIG. 6B).

In this example, the first section 12 has a first dressed profile shape 33. In this example, the second section 18 has a second dressed profile shape 40, wherein the geometry of the first dressed profile shape 38 differs from the geometry of the second dressed profile shape 40.

The grinding worm 10 is set up for topological grinding of the gearing 34 and the grinding of the flanks 36 of the gearing 34 is topological grinding.

Section 12 can be set up for roughing. The section 18 can be set up for finishing. The grinding worm 10 can have several sections 18 for finishing, each of which has a different profile shape for topological grinding.

1. A grinding worm,
wherein the grinding worm is a derisible grinding worm, the grinding worm comprising:
a first section, the first section of the grinding worm has a first abrasive grain which is incorporated in a matrix material,
a second section, the second section of the grinding worm has a second abrasive grain which is incorporated in the matrix material,
wherein the first abrasive grain and the second abrasive grain differ from one another in terms of grain size and/or grain material and/or shape, and
a transition section formed between the first section and the second section, in which both the first abrasive grain and the second abrasive grain are incorporated in the matrix material,
wherein the first section, the second section and the transition section have the same matrix material and
wherein an intermixing of the first abrasive grain and the second abrasive grain is formed at least in sections in the transition section.

2. The grinding worm according to claim 1 wherein
the first section and the second section have been joined together by primary molding,
wherein the transition section forms a material bond between the first section and the second section.

3. The grinding worm according to claim 1, wherein
the first section has a coarser abrasive grain than the second section, or
the second section has a coarser abrasive grain than the first section.

4. The grinding worm according to claim 1,
wherein
the first abrasive grain is an abrasive grain mixture, and/or
the second abrasive grain can be an abrasive grain mixture.

5. The grinding worm according to claim 1, wherein
the first abrasive gran consists of corundum, or
the first abrasive grain consists of silicon carbide, or
the first abrasive grain consists of cubic boron nitride, or
the first abrasive grain consists of synthetic, diamond, or
the first abrasive grain consists of a mixture of abrasive grains consisting of two or more of the following materials: corundum, silicon carbide, cubic boron nitride, synthetic diamond.

6. The grinding worm according to claim 1, wherein
the second abrasive grain consists of corundum, or
the second abrasive grain consists of silicon carbide, or
the second abrasive grain consists of cubic boron nitride, or
the second abrasive grain consists of synthetic diamond, or
the second abrasive grain consists of a mixture of abrasive grains consisting of two or more of the following materials: corundum, silicon carbide, cubic boron nitride, synthetic diamond.

7. The grinding worm according to claim 1, wherein
the grinding worm is a ceramic bonded grinding worm.

8. The grinding worn according to claim 1, wherein
the matrix material comprises one or more of the following materials: clay, kaolin, feldspar, quartz and porcelain powder, calcite, iron oxide, glass frit.

9. The grinding worm according to claim 1, wherein
the grinding worm; is not an electroplated grinding worm.

10. The grinding worm according to claim 1, wherein
the first section has a first dressed profile shape and
the second section has a second dressed profile shape,
wherein the geometry of the first dressed profile shape differs from the geometry of the second dressed profile shape,
wherein the grinding worm is set up for topological grinding of a gearing.

11. A method including the following steps:
providing first abrasive grain;
providing second abrasive grain;
providing a matrix material:
mixing the first abrasive grain with the matrix material to form a first mixture;
mixing the second abrasive grain with the matrix material to form a second mixture;
layering the first mixture and the second mixture in a mold,
pressing the first mixture and the second mixture within the mold and sintering the first and second mixtures to form a cylindrical blank, and
producing a grinding worm by profiling the blank;
wherein the grinding worm is designed according to claim 1.

12. A method including the following steps:
providing a grinding worm according to claim 1;
providing a component which has a gearing to be ground;
grinding the flanks of the gearing by means of the first section; and
grinding the flanks of the gearing by means of the second section.

13. The method according to claim 12, wherein
the grinding worm is a dressable grinding worm and comprises:
a first section, the first section of the grinding worm has a first abrasive grain which is incorporated in a matrix material,
a second section, the second section of the grinding worm has a second abrasive grain which is incorporated in the matrix material,
wherein the first abrasive grain and the second abrasive grain differ from one another in terms of grain size and/or grain material and/or shape, and
a transition section formed between the first section and the second section, in which both the first abrasive grain and the second abrasive grain are incorporated in the matrix material,
wherein the first section, the second section and the transition section have the same matrix material and
wherein an intermixing of the first abrasive grain and the second abrasive grain is formed at least in sections in the transition section,
wherein the first section has a first dressed profile shape and the second section has a second dressed profile shape, wherein the geometry of the first dressed profile shape differs from the geometry of the second dressed profile shape, wherein the grinding worm is set up for topological grinding of a gearing, and
the grinding of the flanks of the gearing is a topological grinding.
